(19) United States
(12) Patent Application Publication
(10) Pub. No.: US 2006/0170172 A1
(43) Pub. Date: Aug. 3, 2006

(54) Roller sled

(75) Inventor: Sin-Mook Kang, Bucheon-si (KR)

Correspondence Address: BACON & THOMAS, PLLC, 625 SLATERS LANE, FOURTH FLOOR, ALEXANDRIA, VA, 22314, US

(73) Assignee: TAYO SPORTS CO., LTD., Seoul (KR)

(21) Appl. No.: 11/319,524

(22) Filed: Dec. 29, 2005

(30) Foreign Application Priority Data
Dec. 30, 2004 (KR) 20-2004-0037310
Feb. 15, 2005 (KR) 10-2005-0012248
Aug. 18, 2005 (KR) 10-2005-0075613
Oct. 5, 2005 (KR) 10-2005-0093273

(51) Int. Cl. B62D 61/06

(52) U.S. Cl. 280/62

(57) ABSTRACT

Disclosed is a roller sled, which comprises a bed 10 whose rear end is inclined upward and which is configured to enable a user's feet to place on its top surface, a steering roller wheel 20 which is mounted at a front end of the bottom surface of the bed 10 and is rotational at a desired angle within the range of 0° to 360°, a flexible support member 30, 40 or 50 whose front end is joined to the bottom surface of the bed 10 which is adjacent to the rear of the steering roller wheel 20 and whose rear end keeps a predetermined distance from the bottom surface of a rear end of the bed 10 up and down and extends to the ground, and a pair of rear roller wheels 60 which is mounted at the rear end of the flexible support member 30, 40 or 50.

### BACKGROUND OF THE INVENTION

1. Field of the Invention

The present invention relates to a roller sled, and more particularly, to a roller sled that is suitable for use in a normal road by enabling a forward running by pushing a stick on the ground in a state where a user stands on a bed of the roller sled wherein roller wheels are mounted on the bottom surface of the bed, and at the same time speeding up by flexibly turning right or left and stretching and folding the user's knee repeatedly and also mitigating a shock from the ground.

2. Description of the Related Art

Generally, sleds are transportation means to transport person or goods by sliding on the ground, snow or ice by placing a pair of sliding plates horizontally and mounting a loading means such as a wooden board thereon. These sleds are largely classified into a kind of ski enjoyed by people and a transport means that is made to slide under a state where person or goods is loaded.

However, the conventional sleds are useful only in the winter season that meets a condition suitable for sliding such as snow or ice in case of at least flat ground because they are configured to run while sliding on the ground by using sliding plates, sticks, etc. Further, in the prior art sleds, simple sliding using the sliding plates could be possible on a slope way of mountains which is covered with grass or plants in the season when there is no snow or ice. However, the existing sleds using the sliding plates are useless on the flat surface of a normal road such as asphalt or paved road with high frictional force.

### SUMMARY OF THE INVENTION

The present invention has been made in order to solve the above problems, and it is, therefore, an object of the present invention to provide a roller sled that is suitable for use in a normal road by enabling a forward running by pushing a stick on the ground in a state where a user stands on a bed of the roller sled wherein roller wheels are mounted on the bottom surface of the bed, and at the same time speeding up by flexibly turning right or left and stretching and folding the user's knee repeatedly and also alleviating a shock from the ground.

To achieve the above objects, there is provided a roller sled comprising: a bed whose rear end is inclined upward and which is configured to enable a user's feet to place on its top surface; a steering roller wheel which is mounted at a front end of the bottom surface of the bed and is rotational at a desired angle within the range of 0° to 360°; a flexible support member whose front end is joined to the bottom surface of the bed which is adjacent to the rear of the steering roller wheel and whose rear end keeps a predetermined distance from the bottom surface of a rear end of the bed up and down and extends to the ground; and a pair of rear roller wheels which are mounted at the rear end of the flexible support member.

In the roller sled according to the embodiment of the present invention, the flexible support member comprises a board plate whose front end is narrow and whose rear end is wide, wherein the rear roller wheel is mounted on both sides of the rear end of the board plate; a hinge which connects the front end of the board plate to the bottom surface of the bed; and a spring which is fixed between the top surface of the rear end of the board plate and the bottom surface of the rear end of the bed.

Further, in the roller sled according to the present invention, it is preferable that a portion adjacent to the rear end of the hinge of the board plate of the flexible support member is formed by a flexible bending section to be twisted by a predetermined angle in a rotational direction when turning the bed.

In the roller sled according to another embodiment of the present invention, the flexible support member comprises a fixing plate whose front end is fixed onto the bottom surface of the bed and whose rear end is bent downward; a flexible plate which is fixed onto the rear end of the fixing plate; and a board plate whose front end is fixed onto the rear end of the flexible plate, wherein the rear roller wheel is mounted on both sides of the rear end of the board plate.

### BRIEF DESCRIPTION OF THE DRAWINGS

The above objects, features and advantages of the present invention will become more apparent from the following detailed description when taken in conjunction with the accompanying drawings, in which:

FIG. 1 shows a perspective view of a roller sled according to a first embodiment of the present invention;

FIG. 2 is a lateral view of the roller sled shown in FIG. 1;

FIG. 3 is a disassembled perspective view of the roller sled depicted in FIG. 1;

FIG. 4 is a schematic lateral view showing a face where a user rides on the roller sled in FIG. 1;

FIG. 5 is a rear view showing a state when the roller sled in FIG. 1 runs straight;

FIG. 6 is a rear view showing a state when the roller sled in FIG. 1 turns left;

FIG. 7 is a rear view showing a state when the roller sled in FIG. 1 turns right;

FIG. 8 is a perspective view showing a state where the sticks are inserted into the stick insertion holes of the roller sled in FIG. 1;

FIG. 9 shows a perspective view of a roller sled according to a second embodiment of the present invention;

FIG. 10 is a lateral view of the roller sled shown in FIG. 9;

FIG. 11 is a disassembled perspective view of the roller sled depicted in FIG. 9;

FIG. 12 is a schematic lateral view showing a face where a user rides on the roller sled in FIG. 9;

FIG. 13 shows a perspective view of a roller sled according to a third embodiment of the present invention;

FIG. 14 is a lateral view of the roller sled shown in FIG. 13;

FIG. 15 is a disassembled perspective view of the roller sled in FIG. 13;

FIG. 16 is a schematic lateral view showing a face where a user rides on the roller sled in FIG. 13;

FIG. 17 is a rear view showing a state when the roller sled in FIG. 13 runs straight;

FIG. 18 is a rear view showing a state when the roller sled in FIG. 13 turns left;

FIG. 19 is a rear view showing a state when the roller sled in FIG. 13 turns right; and

FIG. 20 is a perspective view showing a state where the sticks are inserted into the stick insertion holes of the roller sled in FIG. 13.

### DESCRIPTION OF THE PREFERRED EMBODIMENTS

Although the present invention will now be described through preferred embodiments of a roller sled with reference to the accompanying drawings, the present invention is not limited to those embodiments.

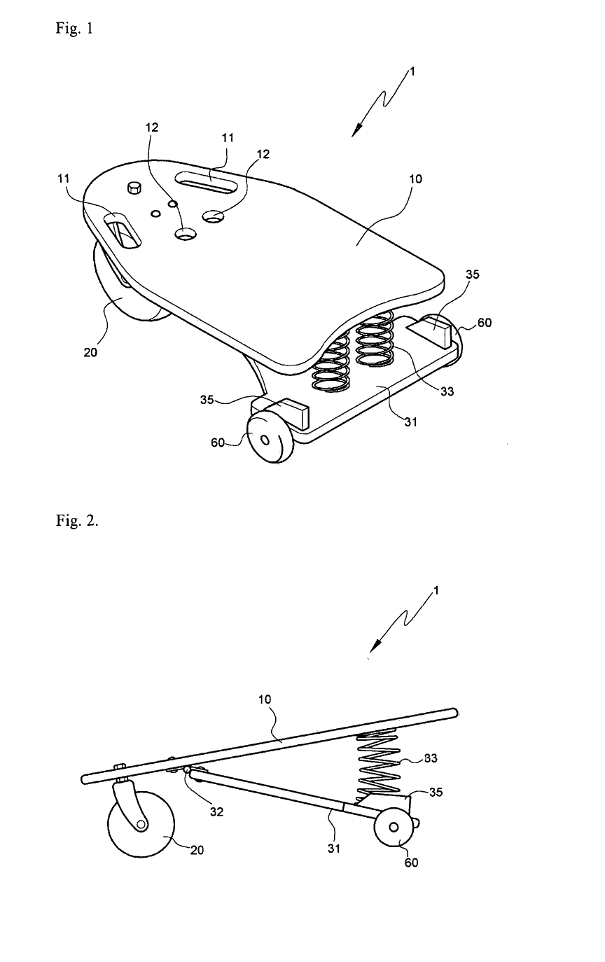

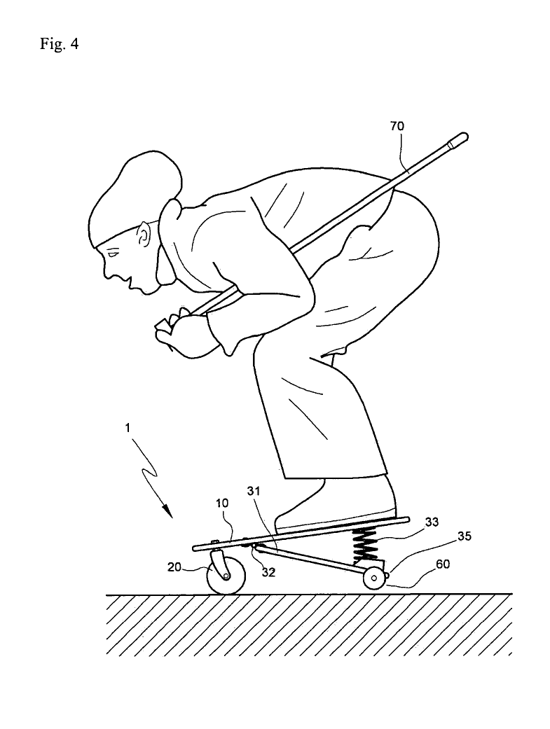

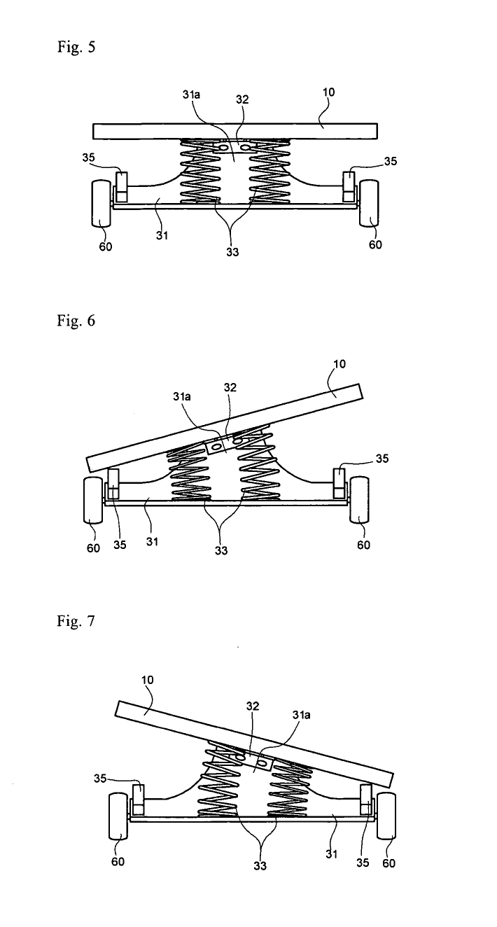

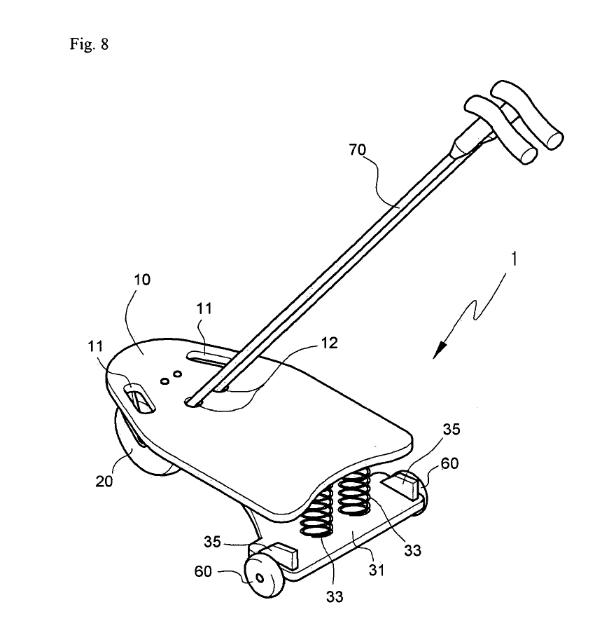

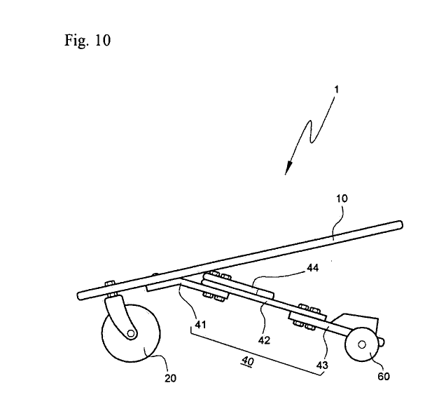

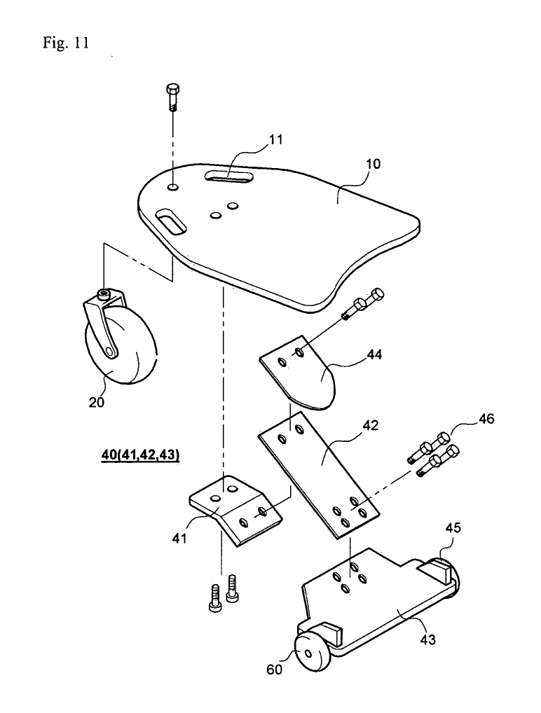

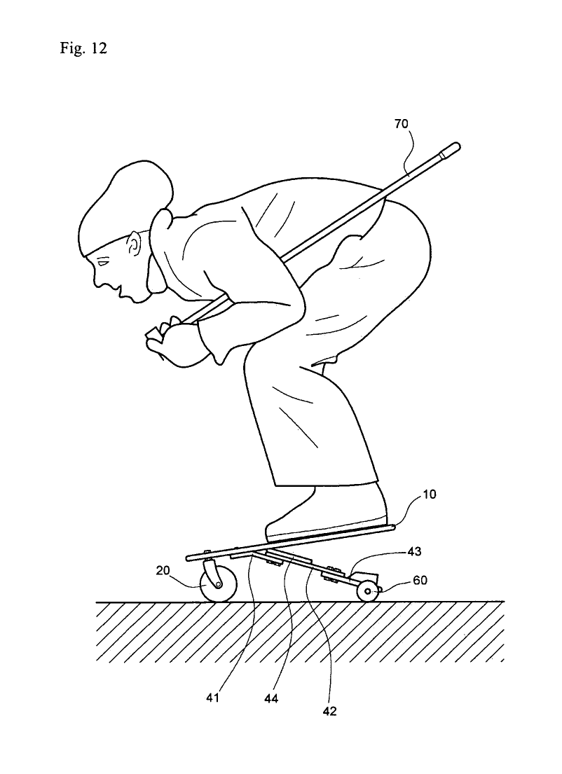

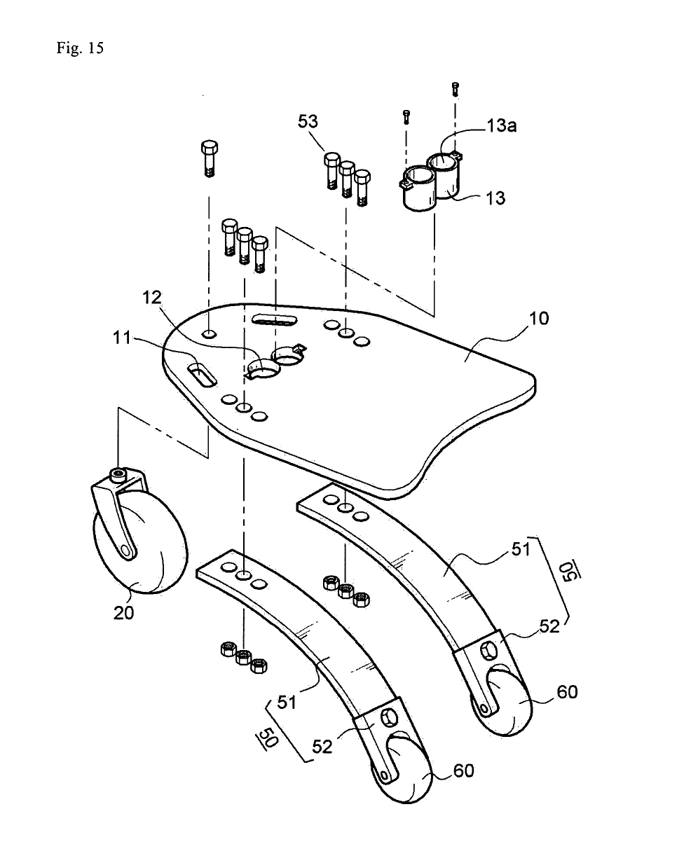

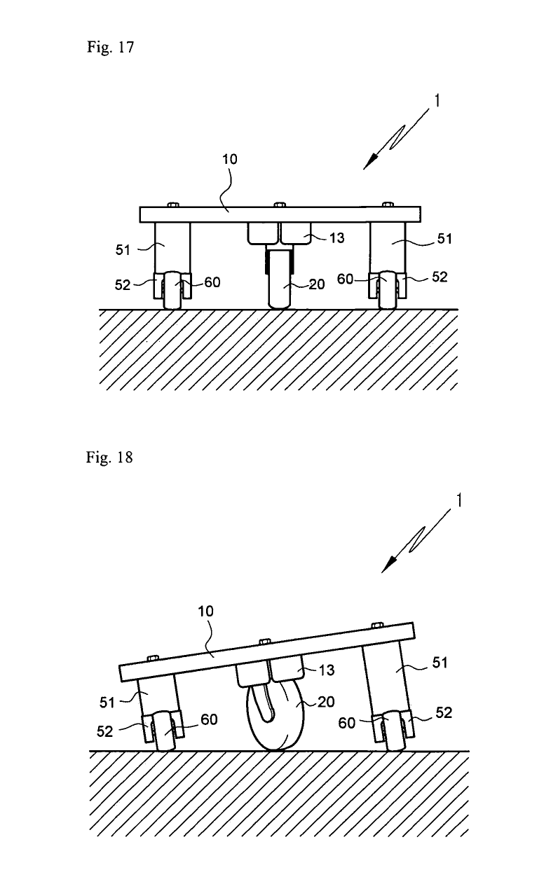

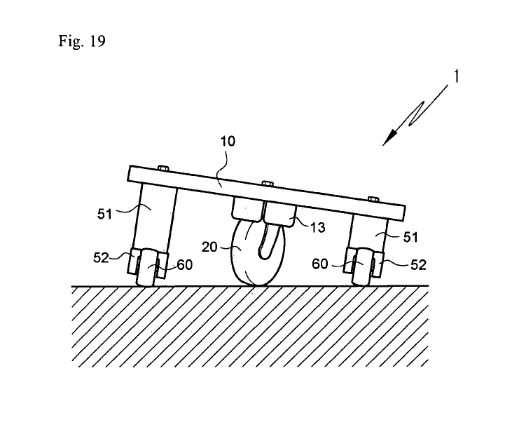

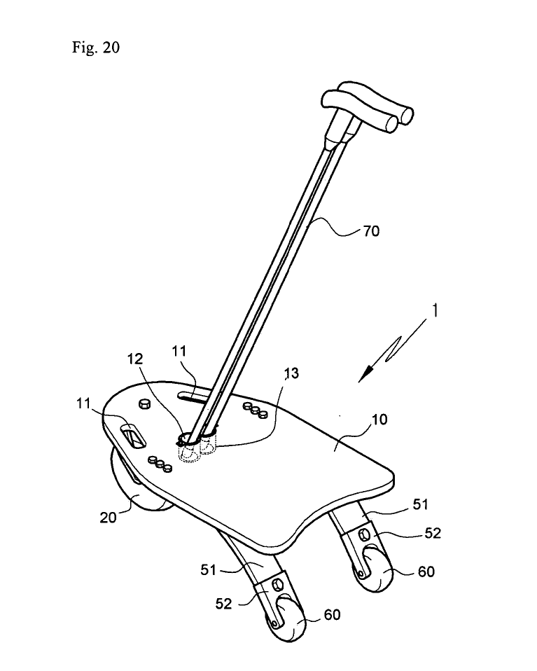

As shown in FIGS. 1-20, the roller sled of the present invention comprises a bed 10 whose rear end is inclined upward and which is configured to enable a user's feet to place on its top surface, a steering roller wheel 20 which is mounted at a front end of the bottom surface of the bed 10 and is rotational at a desired angle within the range of 0° to 360°, a flexible support member 30, 40 or 50 whose front end is joined to the bottom surface of the bed 10 which is adjacent to the rear of the steering roller wheel 20 and whose rear end keeps a predetermined distance from the bottom of a rear end of the bed 10 up and down and extends to the ground, and a pair of rear roller wheels 60 which is mounted at the rear end of the flexible support member 30, 40 or 50.

The bed 10 has a board shape in which its front end is sharp and its rear end is wide, wherein the steering roller wheel 20 which is rotational at a desired angle within the range of 0° to 360° is mounted at the front end of the bottom surface of the bed 10 and the flexible support member 30, 40 or 50 which corresponds to each embodiment of the present invention is mounted at the rear thereof.

In addition, prepared at a predetermined portion of the top of the bed 10 is a gripping slot 11 which is formed in the shape of a pair of elliptic slots that is pierced into along each side of the front end of the bed 10 to insert the user's fingers.

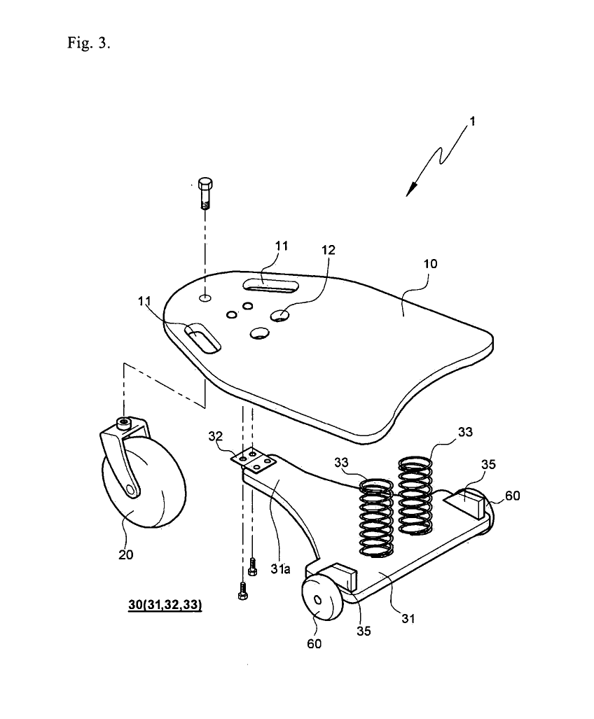

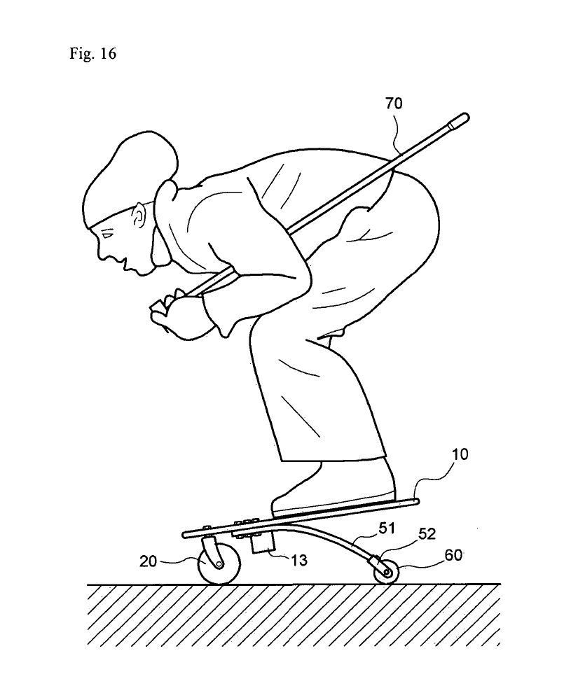

As shown in FIGS. 3 and 15, a stick insertion hole 12 is provided at a portion adjacent to the gripping slot 11 of the bed 10 to keep a stick 70 by inserting the front section thereof.

And also, as shown in FIG. 15, a stick fixing hole 13 having a detachable cylindrical shape fixing hole 13a may be further installed in the stick insertion hole 12.

In this arrangement, if the front section of the stick 70 is inserted into the fixing hole 13a of the stick fixing hole 13, it is suspended on the bottom surface of the airtight fixing hole 13a. Hence, the user can move to a desired place by pushing the bed 10 with the stick 70.

Meanwhile, the flexible support member 30, 40 or 50 is configured to mount the rear roller wheels 60 on the bottom surface of the bed 10 that is adjacent to the steering roller wheel 20 and also to mitigate an impact from the ground. Details thereof will be provided below.

### Embodiment 1

Construction 1 of a Flexible Support Member for a Roller Sled

FIGS. 1-8 show the flexible support member 30 of the roller sled according to a first embodiment of the present invention. The flexible support member 30 comprises a board plate 31 whose front end is narrow and whose rear end is wide, wherein the rear roller wheels 60 are mounted on both sides of the rear end of the board plate 31 respectively, a hinge 32 which connects the front end of the board plate 31 to the bottom of the bed 10 to move the rear end of the board plate 31 up and down, and a spring 33 which is fixed between the top surface of the rear end of the board plate 31 and the bottom surface of the rear end of the bed 10.

Further, a portion adjacent to the rear end of the hinge 32 of the board plate 31 of the flexible support member 30 is formed by a flexible bending section 31a that enables a flexible rotation while being twisted by a predetermined degree in a rotational direction when turning the bed 10.

In addition, the spring 33 is composed of a pair of springs that is spaced by a preset distance in the lateral direction on the same plane so that they strongly and flexibly support the bottom surface of the rear end of the bed 10 to smoothly conduct the turning and shock-absorbing operations.

And also, a pair of stoppers 35 is further provided in order to prevent the rear roller wheel 60 and the bottom of the bed 10 from contacting with the top surface of the board plate 31 adjacent to the rear roller wheel 60.

According to the first embodiment of the roller sled of the invention as structured above, the user can go straight ahead by pushing the stick 70 on the ground in a state where he/she rides on the bed 10. On turning, if the user leans his/her body to a desired direction, the spring 33 on the corresponding bottom portion is compressed while the bed 10 is tilted to the same direction, and at the same time the steering roller wheel 20 turns to the turning direction by the inertia while the flexible bending section 31a of the board plate 31 is bent to the turning direction. As a result, the user can easily make the turning operation.

For example, in case where the user who is running straight while riding the roller sled wants to turn right, if he/she leans his/her body to the right, then the right spring 33 is compressed while the right portion of the bed 10 is pressured downward and simultaneously the steering roller wheel 20 turns to the right to allow the roller sled to be turned right while the flexible bending section 31a of the board plate 31 is being twisted and bent to the right.

In the meantime, any shock arising from the ground during the running due to uneven ground conditions is fully absorbed by the spring 33, and thus is not transmitted to the user of the roller sled.

Further, as shown, the rear end of the bed 10 is inclined upward. Therefore, if the user repeatedly presses the top surface of the bed 10 during the running to change the center of gravity of the user up and down, that is, if the user repeatedly stretchs and folds the user's knee on the bed 10, the rear end of the bed 10 repeatedly goes up and down. By this operation, the front end of the bed 10 slides and proceeds to the forward which help increase the traveling speed of the roller sled.

And, the stopper 35 of the board plate 31 serves to prevent the bottom of the bed 10 from contacting with the rear roller wheels 60 during the moving up and down of the bed 10 due to the plate 35's up and down operation or vibration by uneven ground conditions while the roller sled is running.

Meanwhile, when the user wishes to hold the roller sled after finishing the running thereof, he/she can hold the roller sled by inserting his/her fingers into the gripping slots 11 of the bed 10. Also, when the user wants to keep the roller sled, he/she can keep the roller sled and the stick 70 together by inserting the stick 70 into the stick insertion holes 12 of the bed 10.

### Embodiment 2

### Construction 2 of a Flexible Support Member for a Roller Sled

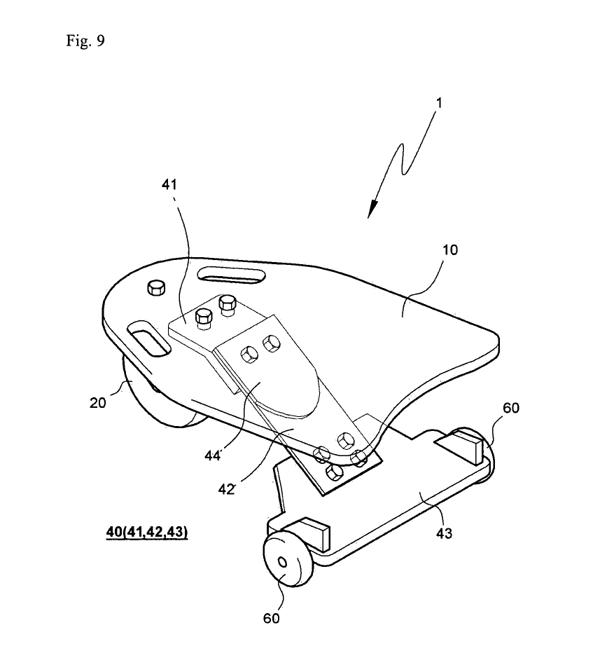

FIGS. 9-12 provide the flexible support member 40 of the roller sled according to a second embodiment of the invention. The flexible support member 40 comprises a fixing plate 41 whose front end is fixed onto the bottom of the bed 10 and whose rear end is bent downward, a rectangular board shape flexible plate 42 which is fixed onto the rear end of the fixing plate 41, and a board plate 43 whose front end is fixed onto the rear end of the flexible plate 42 and whose rear end's both sides are fixed to the rear roller wheels 60 for its axial rotation, respectively.

In addition, provided on the top of the front end of the flexible plate 42 is an auxiliary flexible plate 44 that enables the flexible plate 42 to be endured against an increase of the user's weight.

In this structure, the bed 10, the fixing plate 41, the flexible plate 42, the board plate 43 and the auxiliary flexible plate 44 are strongly joined together by bolts 46.

And also, a stopper 45 is further prepared in order to prevent the rear roller wheels 60 and the bottom surface of the bed 10 from contacting with the top surface of the board plate 43 adjacent to the rear roller wheels 60.

According to the second embodiment of the roller sled of the invention as configured above, the user can go straight ahead by pushing the stick 70 on the ground in a state where he/she rides on the bed 10. On turning, if the user leans his/her body to a desired direction, the bed 10 is tilted to that direction, and at the same time the steering roller wheel 20 turns to the turning direction by the inertia while the flexible plate 42 between the bed 10 and the board plate 43 is bent to the turning direction. In the result, the user can easily make the turning operation.

For example, in case where the user who is running straight while riding the roller sled wants to turn right, if he/she leans his/her body to the right, then the right side of the bed 10 is compressed downward and at the same time the steering roller wheel 20 turns to the right to allow the roller sled to be turned right while the flexible plate 42 is twisted and bent to the right.

In the meantime, the flexible plate 42 fully absorbs any shock arising from the ground during the running due to uneven ground conditions, thereby preventing it from transmitting to the user of the roller sled.

The auxiliary flexible plate 44 which is fixed onto the front end of the top surface of the flexible plate 42 serves prevent breakdown of the flexible plate 42 due to an increased load thereto such as an increase in the user's weight, etc.

Further, as shown, the rear end of the bed 10 is inclined upward. Therefore, if the user repeatedly presses the top surface of the bed 10 during the running to change the center of gravity of the user up and down, that is, if the user repeatedly stretches and folds the user's knee on the bed 10, the rear end of the bed 10 repeatedly goes up and down. By this operation, the front section of the bed 10 slides and proceeds to the forward which helps increase the traveling speed of the roller sled.

And, the stopper 45 of the board plate 43 functions to prevent the bottom surface of the bed 10 from contacting with the rear roller wheels 60 during the moving up and down of the bed 10 due to the plate 43's up and down operation or vibration by uneven ground conditions while the roller sled is running.

Meanwhile, the roller sled according to the second embodiment of the invention can prevent breakdown of the joints between the components due to the twisting, etc. of the flexible plate 43 by the turning operation because the bed 10, the fixing plate 41, the flexible plate 42, the board plate 43 and the auxiliary flexible plate 44 are strongly joined together by the bolts 46.

### Embodiment 3

### Construction 3 of a Flexible Support Member for a Roller Sled

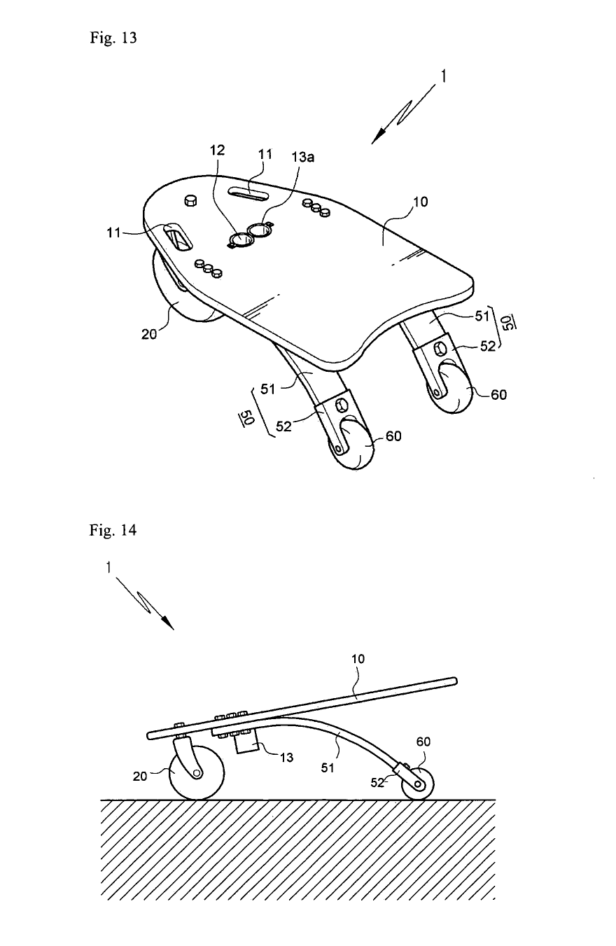

FIGS. 13-20 present the flexible support member 50 of the roller sled according to a third embodiment of the invention. The flexible support member 50 comprises a pair of flexible bars 51 whose front ends are fixed onto the bottom of the bed 10 and whose rear ends are bent downward in a round shape to be spaced by a preset distance up and down from the bottom surface of the rear end of the bed 10, and which is spaced at a preset distance in the lateral direction, and a pair of fixing plates 52 whose front ends are fixed to the rear ends of the flexible bars 51, wherein the rear roller wheels 60 are mounted on the rear ends of the fixing plates 52.

Hereinafter, details of the structures of the flexible bars 51 and the fixing plates 52 and the connections therebetween will be given. Each of the flexible bars 51 is formed in the shape of a thin curvilinear board; and the corresponding fixing plate 52 has a structure that includes an insertion portion on its front side which enables the rear end of the flexible bar 51 to be inserted thereinto and a concave portion prepared at its center in order to install the rear roller wheels 60 on its rear end. In this structure, if the flexible bars 51 are inserted into the insertion portion of the fixing plates 52, they are joined by bolts and the rear roller wheels 60 are inserted into the concave portion of the fixing plates 52, to thereby adhere to an axis for the axial rotation.

Meanwhile, the bed 10 and the flexible bars 51 are also strongly joined together by the bolts 53.

According to the third embodiment of the roller sled of the invention as constructed above, the user can run straight by pushing the stick 70 on the ground in a state where he/she rides on the bed 10. When turning, if the user leans his/her body to a desired direction, the bed 10 is tilted to that direction, and at the same time the corresponding flexible bar 51 of the bottom surface of the bed 10 is stretched by its pressure whereas the opposite flexible bar 51 is further bent due to the load's decrease. In result, the steering roller wheel 20 turns to the turning direction by the inertia, so that the user can easily make the turning operation.

For example, in case where the user who is running straight while riding the roller sled wants to turn right, if he/she leans his/her body to the right, then the right side of the bed 10 is compressed downward and at the same time the corresponding flexible bar 51 of the bottom surface of the bed 10 is stretched by its pressure whereas the opposite flexible bar 51 is further bent due to the load's decrease. As a result, the steering roller wheel 20 turns right by the inertia to allow the roller sled to be turned right.

In the meantime, the pair of flexible bars 51 fully absorbs any impact from the ground during the running due to uneven ground conditions, thereby preventing it from delivering to the user of the roller sled.

Further, as shown, the rear end of the bed 10 is inclined upward. Hence, if the user repeatedly presses the top surface of the bed 10 during the running to change the center of gravity of the user up and down, that is, if the user repeatedly stretches and folds the user's knee on the bed 10, the rear end of the bed 10 repeatedly goes up and down. By this operation, the front section of the bed 10 slides and proceeds to the forward which helps increase the traveling speed of the roller sled.

And also, the bed 10, the flexible bars 51 and the fixing plates 52 are strongly joined together by the bolts 53; and accordingly, the roller sled in accordance with the third embodiment of the invention can prevent breakdown of the joints between the components due to the flexible modification such as the bending and stretching, etc. of the flexible bars 51 by the turning operation.

Meanwhile, when the user wishes to hold the roller sled after finishing the running thereof, he/she can hold the roller sled by inserting his/her fingers into the gripping slots 11 of the bed 10. Also, when the user wants to keep the roller sled, he/she can keep the roller sled and the stick 70 together by inserting the stick 70 into the fixing hole 13a of the stick fixing hole 13. In addition, the user can also move the roller sled to any desired place while pushing it with the stick 70 by inserting the stick 70 into the fixing hole 13a of the stick fixing hole 13, as set forth above.

What is claimed is:

1. A roller sled comprising:
a bed 10 whose rear end is inclined upward and which is configured to enable a user's feet to place on its top surface;
a steering roller wheel 20 which is mounted at a front end of the bottom surface of the bed 10 and is rotational at a desired angle within the range of 0° to 360°;
a flexible support member 30, 40 or 50 whose front end is joined to the bottom surface of the bed 10 which is adjacent to the rear of the steering roller wheel 20 and whose rear end keeps a predetermined distance from the bottom surface of a rear end of the bed 10 up and down and extends to the ground; and
a pair of rear roller wheels 60 which is mounted at the rear end of the flexible support member 30, 40 or 50.

2. The roller sled according to claim 1, wherein the flexible support member 30 comprises:
a board plate 31 whose front end is narrow and whose rear end is wide, wherein the rear roller wheels 60 are mounted on both sides of the rear end of the board plate 31, respectively;
a hinge 32 which connects the front end of the board plate 31 to the bottom surface of the bed 10; and
a spring 33 which is fixed between the top surface of the rear end of the board plate 31 and the bottom surface of the rear end of the bed 10.

3. The roller sled according to claim 2, wherein a portion adjacent to a rear end of the hinge 32 of the board plate 31 of the flexible support member 30 is formed by a flexible bending section 31a to be twisted by a predetermined angle in a rotational direction when turning the bed 10.

4. The roller sled according to claim 2, wherein the spring 33 is comprised of a pair of springs that is spaced by a preset distance in the lateral direction on the same plane.

5. The roller sled according to claim 2, further comprising a stopper 35 in order to prevent the rear roller wheels 60 and the bottom surface of the bed 10 from contacting with the top surface of the board plate 31 or 43 adjacent to the rear roller wheels 60.

6. The roller sled according to claim 1, wherein the flexible support member 40 comprises:
a fixing plate 41 whose front end is fixed on the bottom surface of the bed 10 and whose rear end is bent downward;
a flexible plate 42 which is fixed onto the rear end of the fixing plate 41; and
a board plate 43 whose front end is fixed onto the rear end of the flexible plate 42, wherein the rear roller wheels 60 are mounted on both sides of the rear end of the board plate 43, respectively.

7. The roller sled according to claim 6, further comprising an auxiliary flexible plate 44 arranged on the top surface of the front end of the flexible plate 42.

8. The roller sled according to claim 5, further comprising a stopper 45 in order to prevent the rear roller wheels 60 and the bottom surface of the bed 10 from contacting with the top surface of the board plate 31 or 43 adjacent to the rear roller wheels 60.

9. The roller sled according to claim 1, wherein the flexible support member 50 comprises:
a pair of flexible bars 51 whose front ends are fixed on the bottom surface of the bed 10 and whose rear end are bent downward to be spaced by a preset distance up and down from the bottom surface of the rear end of the bed 10, and which is spaced at a preset distance in the lateral direction; and
a pair of fixing plates 52 whose front ends are fixed onto the rear ends of the flexible bars 51, wherein the rear roller wheels 60 are mounted at the rear ends of the fixing plates 52.

10. The roller sled according to claim 1, further comprising a gripping slot 11 provided at a preset place of the top surface of the bed 10.

11. The roller sled according to claim 10, wherein the gripping slot 11 is comprised of a pair of elliptic shape slots that is pierced into along each side of the front end of the bed 10.

12. The roller sled according to claim 1, further comprising a stick insertion hole 12 prepared at a predetermined portion of the bed 10 to insert a front end of a stick 70.

13. The roller sled according to claim 12, further comprising a detachable cylindrical shape stick fixing hole 13 provided in the stick insertion hole 12.
